(19) United States
(12) Patent Application Publication
(10) Pub. No.: US 2010/0094184 A1
(43) Pub. Date: Apr. 15, 2010

(54) AIR BAG AND AN APPARATUS AND SYSTEM HAVING THE SAME

(76) Inventors: Wai Mun James Wong, Singapore (SG); Boon Buan Lim, Singapore (SG); Kia Tong Tan, Singapore (SG)

Correspondence Address: SEED INTELLECTUAL PROPERTY LAW GROUP PLLC, 701 FIFTH AVE, SUITE 5400, SEATTLE, WA, 98104, US

(21) Appl. No.: 12/447,232

(22) PCT Filed: Oct. 27, 2006
(86) PCT No.: PCT/SG06/00316

§ 371 Date: Dec. 17, 2009

(51) Int. Cl. A61H 9/00; A43B 13/20; A43B 7/00; A43B 13/04

(52) U.S. Cl. 601/149; 36/29

(57) ABSTRACT

An air bag having a first monolithic layer and a second monolithic layer, said first and second monolithic layer being attached to each other along a closed line such that the surface area of the first monolithic layer within the closed line is larger than the surface area of the second monolithic layer within said closed line. The first monolithic layer and the second monolithic layer define a fluid chamber bounded by said closed line, wherein the first monolithic layer rests on the second monolithic layer, and is of an at least substantially corrugated shape when said fluid chamber is deflated. The air bag also includes at least one fluid port in fluid communication with the fluid chamber.

The present invention relates to the field of air bags, and more specifically, to an air bag for applying massage forces to a body.

Massage chairs and beds provide their respective users with a massage that alleviates certain medical conditions. Examples of some conditions that a massage can alleviate include improving blood circulation, relieving stress and relaxing tense muscles. In order to provide an effective massage, massage devices typically employ force applicators that apply forces to a body of a user. These force applicators knead, tap, roll or press against the body to generate the effect of a massage. Typically such force applicators are mechanical rollers. However, in order to allow a mechanical roller to perform the aforesaid motions, the control and actuation mechanisms required are complex and numerous and therefore, contribute substantially to the cost of the massage device using such mechanical force applicators. Furthermore, such mechanisms are also difficult to implement in smaller applications such as in footwear, for example.

In view of the limitations of the mechanical force applicators, several massage devices have turned to air bags as substitutes to the conventional roller force applicator. By doing so, the amount of control and actuation mechanisms required by the air bag-based massage chairs and beds have been reduced. Furthermore, the air bags and their corresponding mechanisms may be suitably scaled in size in order that said air bags may be used in applications such as in foot massaging devices.

An example of such a foot massaging device is described in United States patent application 2002/0133106 A1, which discloses a piece of footwear having at least three independently inflatable air bags that are distributed along the sole of the footwear. The air bags are formed of two planar layers attached along their respective peripheries thereby forming there between a fluid chamber. The air bags exert a massaging force on a foot of a user when inflated. However, the massaging force exerted by the air bags is limited in part to the elasticity of the material used to form said air bags. Furthermore, the planar nature of the layers that form the air bag also limits the height to which the air bags may be inflated to, thereby limiting the projection (and massage force) of the air bag into the foot of the user.

PCT application WO 2006/065225 A1 also discloses a similar planar air bag, wherein said air bag is formed by planar monolithic layers bonded at their peripheries. The extent of the massage force exerted by the air bags onto a foot (or body) of a user is again limited by the elasticity of the material used to form said air bags. Furthermore, the planar nature of the layers that form the air bag also limits the height to which the air bags may be inflated to. Although in one embodiment, the PCT application describes a stacking of two air bags in an overlapping relationship in order to increase the massage force applied to the foot (or body), such an arrangement raises implementation difficulties especially when the space within which the air bags are to be fitted is constrained.

Accordingly, there remains a need for an air bag that is compact, is of simple construction and is yet capable of expanding sufficiently enough in order to apply a sufficient massage force to the body of a user. In addition, such an air bag should be simple and cost effective to manufacture. In this respect, an air bag according to the present invention, and as defined in the appended claims, overcomes the aforesaid difficulties.

The air bag of the present invention includes a first monolithic layer and a second monolithic layer, wherein the first and second monolithic layers are attached to each other along a closed line. The surface area of the first monolithic layer within the closed line is larger than the surface area of the second monolithic layer within said closed line. By way of being attached to each other, the first monolithic layer and the second monolithic layer define there between a fluid chamber that is bounded by said closed line. The first monolithic layer rests on the second monolithic layer and is of an at least substantially corrugated shape when said fluid chamber is deflated. The air bag also includes at least one fluid port in fluid communication with the fluid chamber.

In one embodiment of the air bag, the first monolithic layer within the closed line, i.e. its surface area within said closed line, may be shaped into a plurality of ridges and grooves and/or a plurality of waveforms.

In another embodiment of the invention, the ridges and grooves and/or the waveforms may be at least substantially concentric. In other words, the surface area of the first monolithic layer within the closed line may be rippled and have a plurality of concentric waveforms originating from a point within the closed line, and extending outwards to the closed line.

In all the embodiments described herein, it is to be noted that the shape and form of the second monolithic layer is typically, though not necessarily, substantially planar while that of the first monolithic shape, as mentioned, is substantially corrugated and rests on the second monolithic layer when the fluid chamber is deflated. The corrugated shape of the first monolithic layer may be achieved by first manually folding said layer to have, as in the case of the above-mentioned embodiment, concentric waveforms for example. This is then followed by the attaching of the folded first monolithic layer to the substantially planar second monolithic layer along the closed line as mentioned above.

Alternatively, especially in the case of mass production, the first and second monolithic layers may be molded via molding processes such as press-fit molding, injection molding, blow molding, vacuum forming or thermoforming, for example. Generally, the first and second monolithic layers may be formed separately or simultaneously within a suitable mold and attached to each other along the closed line.

The attachment of the first monolithic layer to the second monolithic layer along the closed line, whether the air bag is fabricated by manual means or otherwise, may be carried out by any suitable method. Examples of such suitable methods include, but are not limited to, solvent bonding, ultra-violet (UV) bonding, ultra-sonic bonding, thermal bonding and/or adhesion bonding. These methods may also be employed to attach the first monolithic layer to the second monolithic layer along lines apart from the closed line, details of which follow later on.

In yet another embodiment, the first and second monolithic layers may be of a single layer. In this embodiment, the air bag may also be fabricated manually by having a first portion of the single layer folded over a remaining portion of the single layer. The periphery, or any other part, of the first portion is then attached to the remaining portion along a closed line, such that said first portion and remaining portion, along with the bounded closed line, define therebetween a fluid chamber.

In this embodiment, where the first and second monolithic layers are of a single layer, forming the airbag may also be carried out via a first molding step to form the single layer followed by a second molding step that gives the corrugated shape to the first portion (via thermoforming, for example). Subsequently, the attachment of the shaped first portion to the remaining portion along said closed line may be carried out by any of aforesaid attachment methods.

Where the first and second monolithic layer are of a single layer, the first portion of the single layer may be taken to be the first monolithic layer while the remaining portion which is folded under said first portion may be taken to be the second monolithic layer. Accordingly, prior to attaching (or folding) the first portion, said first portion should be suitably shaped, as mentioned above, in order to be at least substantially corrugated. As in the previous embodiments, either the first portion or the remaining portion may include a fluid port, as long as the fluid port is located (on either portion) in a position such that when the fluid chamber is defined as described above, said fluid port is in fluid communication with the fluid chamber, which is defined by the first portion and the remaining portion bounded by the closed line.

In a further embodiment of the invention, the first monolithic layer may include at least one node located on its outer surface and within the closed line. The node is typically a hardened part that is situated such that it is driven into a body of a user when the fluid chamber is inflated. As such, the node itself may have a pointed tip, or a parabolic tip or any other suitably shaped tip for it to apply or enhance the massage force to a body when the fluid chamber is inflated.

In one embodiment of the invention, the first and second monolithic layers are further attached to each other along at least one attachment line. The attachment line is within the closed line and thus, sub-divides the fluid chamber into at least two sub-chambers. In one exemplary embodiment, the attachment line may be another closed line that defines one of the sub-chambers. As it is a closed line, no fluid communication between the sub-chambers is possible. Accordingly, the fluid chamber defined by the closed attachment line includes at least one fluid port in fluid communication therewith. It follows that in a further exemplary embodiment, where a plurality of closed attachment lines are present, each sub-chamber defined by said closed attachment lines includes its own fluid port in fluid communication on therewith.

In another exemplary embodiment where the first and second monolithic layers are further attached to each other along at least one attachment line, the attachment line may not be a closed line. Accordingly, in this exemplary embodiment, the sub-chambers are in fluid communication with each other. In a further exemplary embodiment, where two or more attachment lines are present, the attachment lines may be located such that they define a plurality (two or more) sub-chambers, each in fluid communication with each other.

In all the embodiments of the invention described herein, the first and second monolithic layers may be polymeric materials suited for molding. Examples of such polymeric materials suited for molding include, but are not limited to, thermoplastic polyurethane (TPU), polyvinyl chloride (PVC), polypropylene, Nylon cloth grade 420d, Nylon cloth grade 210d and/or polyethylene (PE).

It should be noted that the fluid intended to inflate the fluid chamber and/or sub-chambers may be any suitable fluid such as a liquid or a gas. Examples of fluids that may be used include, but are not limited to, water, or gases such as nitrogen (N₂), air and noble gases such as argon (Ar), Helium (He) or Neon (Ne).

The air bag of the present invention may be of any suitable shape. In this respect, the overall shape of the inflatable portion of the air bag, i.e. the fluid chamber, is primarily governed by the shape of the closed line. Examples of shapes that the closed line may be formed of include but are not limited to, shapes that are at least substantially rectangular, polygonal, circular and/or elliptical.

Another aspect of the present invention relates to an air bag apparatus. The air bag apparatus includes an air bag as described in any of the aforesaid embodiments and a fluid pump system that is connectable (possibly in a removable manner via a docking mechanism) to the fluid port of the air bag.

The fluid pump system of the air bag apparatus includes a fluid pump. The connection of the fluid pump to the air bag may be through intermediate fluid flow tubes, for example. The fluid pump system may also include a controller, wherein said controller regulates the fluid pump, and a valve for controlling the inflation and deflation of the air bag of the apparatus. The fluid pump system may also include a pressure regulatory sensor in connection with the fluid pump and/or air bag. The fluid pump, controller, valve and pressure regulatory sensor may each be electrically coupled to either a single power source or to independent power sources.

As mentioned, the fluid pump system also includes a docking mechanism to allow for the fluid pump system to be connected to the air bag. The docking mechanism comprises two parts with one part located on the fluid pump system and the other part located on the air bag. The docking mechanism of the fluid pump system is essentially complementary to the docking mechanism found on the air bag, i.e. such as in a plug and socket, for example.

In one illustrative embodiment, the docking mechanism of the fluid pump system includes a housing. The housing includes at least one fluid flow tube. One end of the fluid flow tube is in fluid connection with the valve and therefore, with the fluid pump system while the other end is adapted, along with the housing to be connectable to the complementary docking mechanism found on the air bag. The docking mechanism on the air bag also includes a housing having at least one fluid flow tube therein, wherein one end of the tube is adapted to be connectable to the docking mechanism of the fluid pump system and the other end of the tube is connected to the air bag(s).

In the above illustrative embodiment of the docking mechanism, the fluid flow tube of the air bag may be also coupled to a flow valve that is capable of varying the rate of fluid flow (in the form of a radial dial, for example) from the fluid pump system to the docked air bag.

Another aspect of the present invention relates to a massage shoe system. The massage shoe system includes a pair of shoes, each having at least four air bags arranged therein. Each air bag includes a first monolithic layer and a second monolithic layer, wherein said first and second monolithic layers are attached to each other along a closed line. The surface area of the first monolithic layer within the closed line is larger than the surface area of the second monolithic layer within said closed line such that the first monolithic layer and the second monolithic layer define a fluid chamber bounded by said closed line. The first monolithic layer rests on the second monolithic layer and is of an at least substantially corrugated shape when said fluid chamber is deflated. In addition, the air bag includes at least one fluid port in fluid communication with the fluid chamber.

Essentially, any of the embodiments of the air bag as described above may be used in connection with the massage shoe system. In the implementation of any of the embodiments of the air bag into the shoe, space constraints are typically taken into consideration. In this respect, one embodiment of the massage shoe system includes a shoe having at least one recessed cup located on the sole of the shoe. The recessed cup is adapted such that it is capable of housing at least one air bag. For optimal comfort to a user of the shoe, the recess should be of a sufficient depth such that when the air bag is accommodated therein, the surface of the sole surrounding the recess, and the surface of the air bag at the opening of the recess should be at least substantially congruous.

In one exemplary embodiment of the shoe having the recess, said recess may be located in the heel region. Alternatively, in another exemplary embodiment, the recess may be located in the mid-sole region of the shoe.

In one specific exemplary embodiment of the massage shoe system where each shoe has four air bags therein, two of the four air bags are arranged on or in the sole of the shoe to provide a massage force to the heel region and/or sole region of a foot and the remaining two air bags are arranged along the lateral walls of the shoe to provide a massage force to the vamp region, plantar arch region and/or lateral region of the foot. The arrangement of the air bags is not limited to those regions mentioned above, and may also include other areas of the foot such as the calcaneal tubercle region, sides of the calcaneus, the tarsal region, the dorsal region and the digital region, for example.

In another exemplary embodiment, the massage shoe system includes boots instead of shoes. The boots may be hi-cut or low-cut, meaning that said boots may extend from the foot to the ankle or further up to the calf region. In this exemplary embodiment, the arrangement of air bags within the boot may be such that the lateral crural region, tarsal region and sural region are provided with a massaging means.

In another embodiment of the massage shoe system, each of the four air bags may be arranged beneath a layer of elastic material. This is done in order to provide for a more congruous surface over the sole of the shoe for the comfort of the user. In this embodiment, as the foot of a user only directly contacts the elastic material, the foot experiences massage forces, from the inflation of the air bags, via said elastic material, which stretches to accommodate the expanding air bag.

Although any suitable elastic material may be used, in one specific exemplary embodiment, the elastic material used is neoprene. The use of neoprene prevents the accumulation of heat within the shoe during any massage sequence thereby reducing the formation of sweat and unpleasant odors, Apart from neoprene, Nylex or any other suitable elastic material that serves the same purpose may also be used.

In a further embodiment of the massage shoe system, the heel region and/or the sole region of the shoe may include a docking mechanism. The docking mechanism is typically adapted to dock with an independent power supply and/or an air bag apparatus as described above.

The various aspects of the present invention will now be described with reference to the following illustrated exemplary embodiments of the present invention in which:

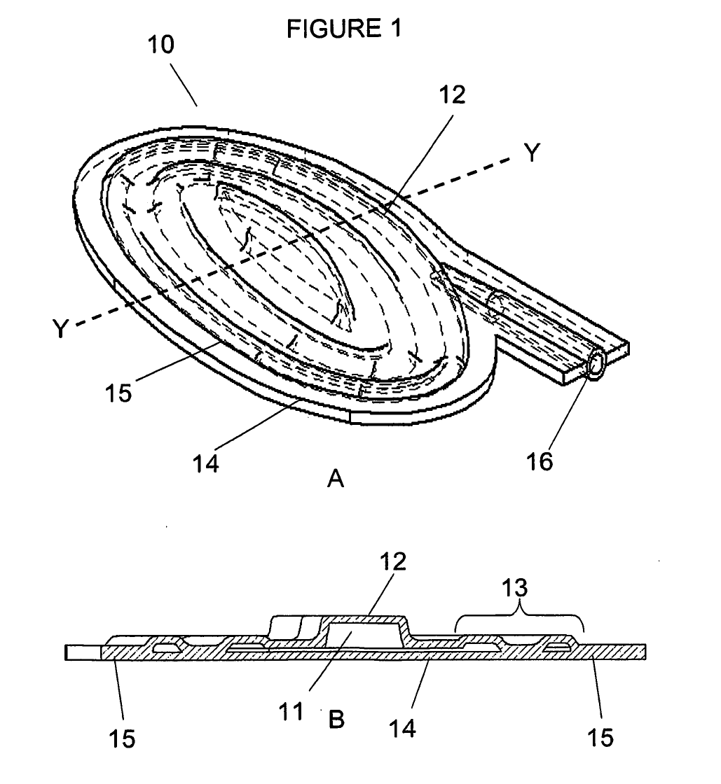

FIG. 1A shows an embodiment of an air bag according to the present invention in a deflated state;

FIG. 1B shows a cross-sectional view about a line Y-Y of the embodiment of FIG. 1A;

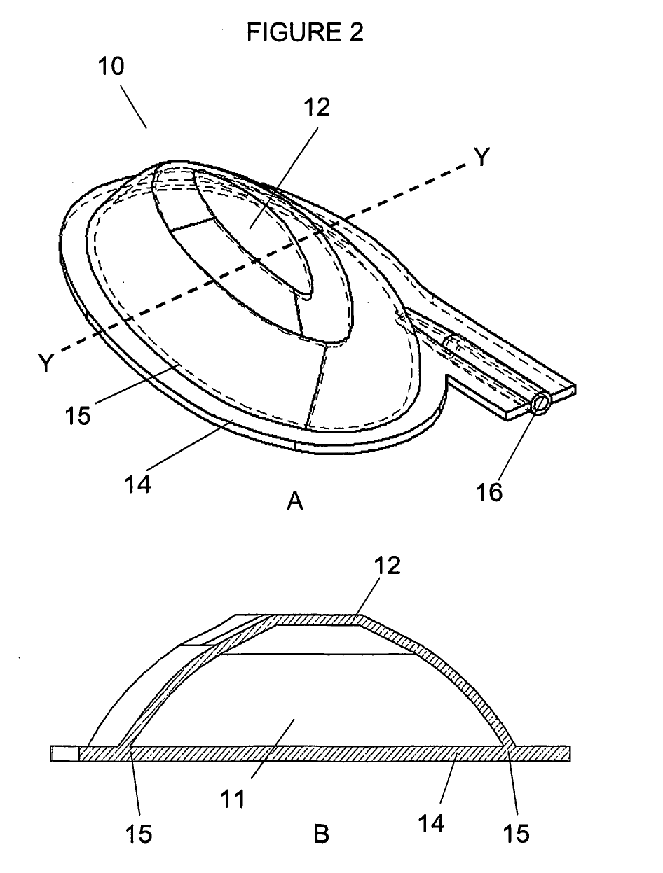

FIG. 2A shows the embodiment of FIG. 1A in an inflated state;

FIG. 2B shows a cross-sectional view about the line Y-Y of the embodiment of FIG. 2A;

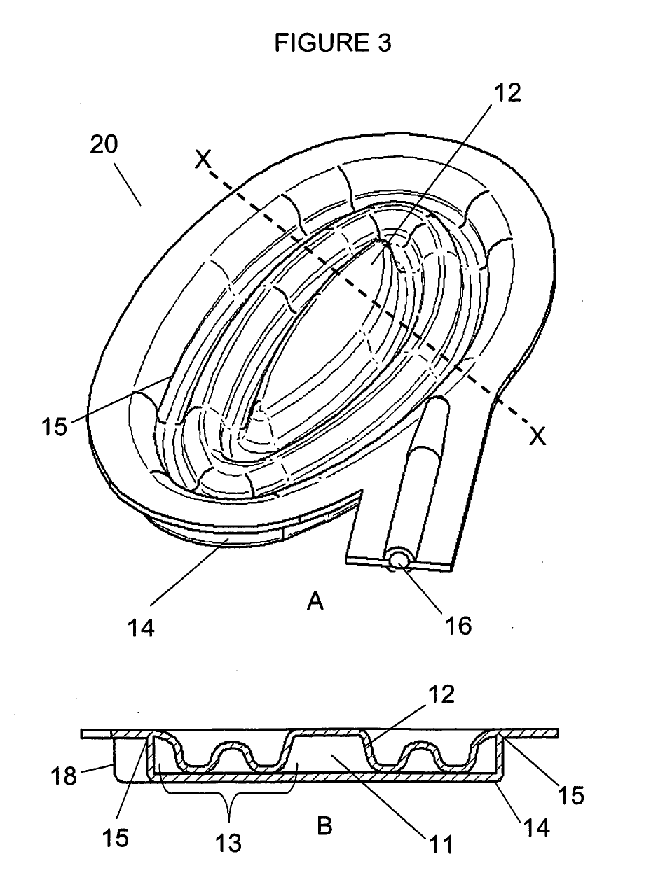

FIG. 3A shows another embodiment of an air bag according to the present invention in a deflated state;

FIG. 3B shows a cross-sectional view about a line X-X of the embodiment of FIG. 3A;

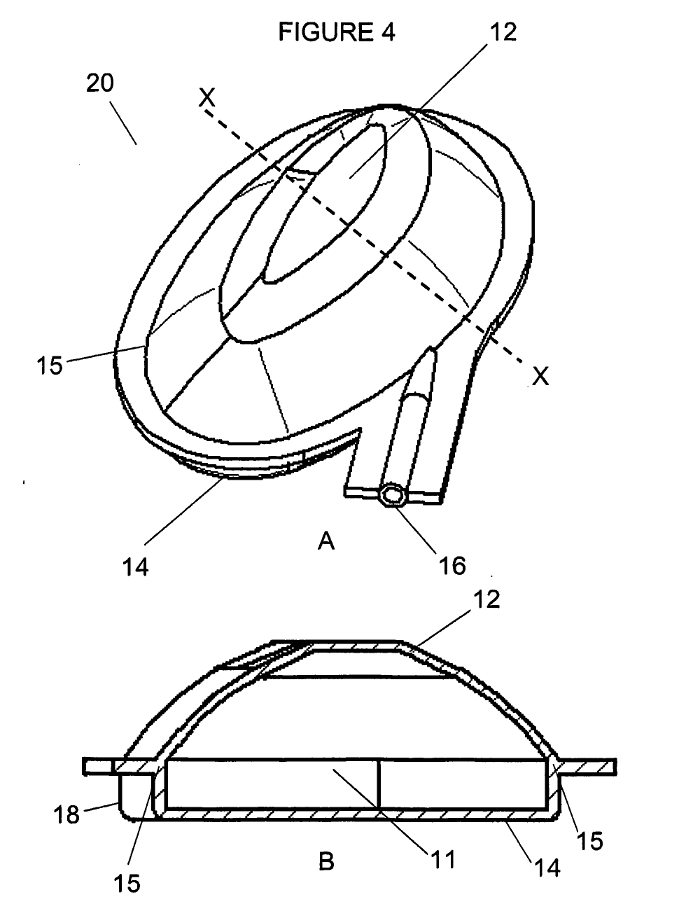

FIG. 4A shows the embodiment of FIG. 3A in an inflated state;

FIG. 4B shows a cross-sectional view about the line X-X of the embodiment of FIG. 4A;

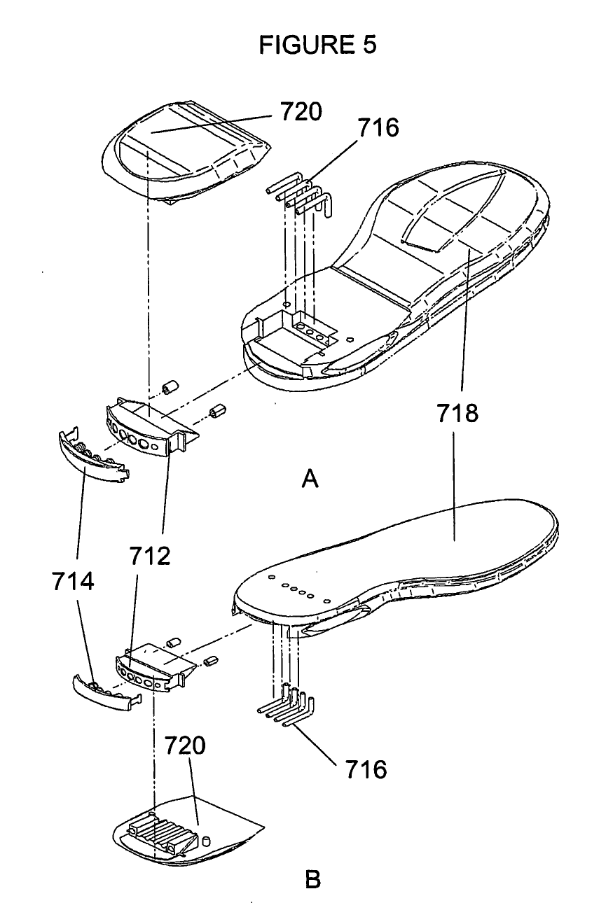

FIG. 5 shows an exploded view of a docking mechanism that forms part of a shoe massage system;

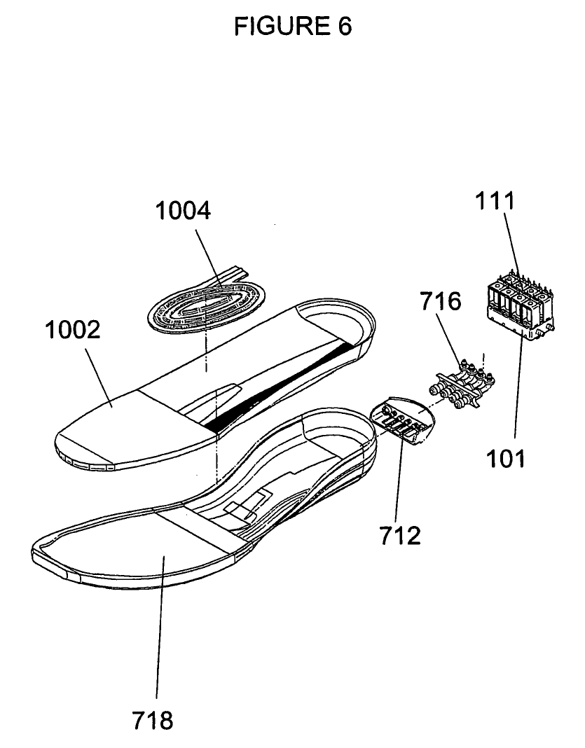

FIG. 6 shows an exploded view of a sole of a shoe massage system;

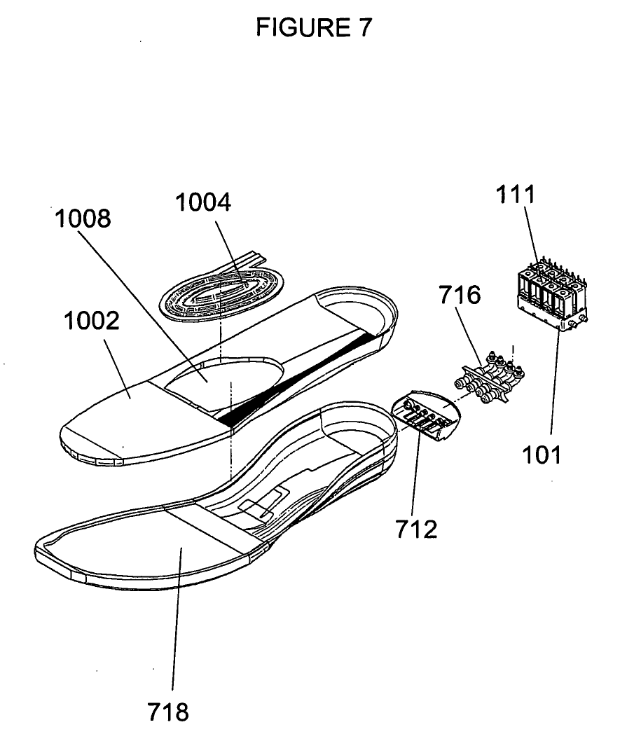

FIG. 7 shows an exploded view of another embodiment of a sole of the shoe massage system of FIG. 6; and

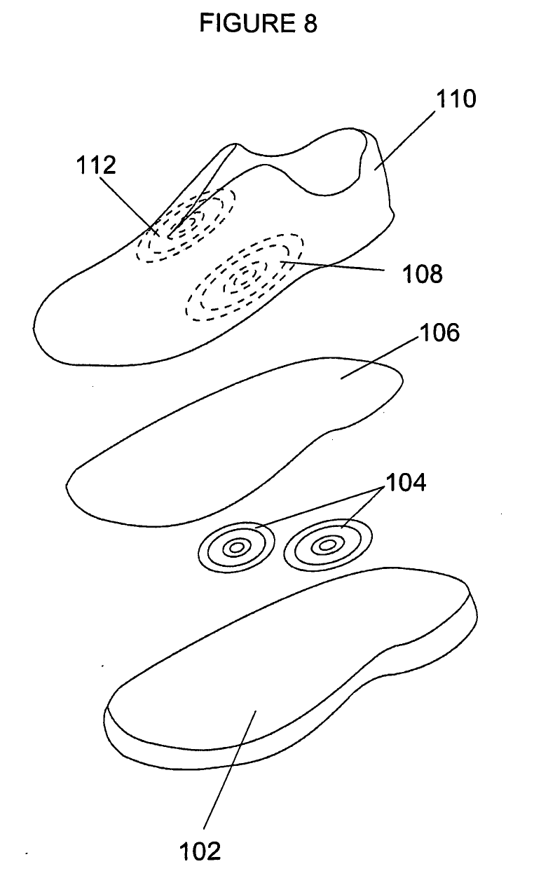

FIG. 8 shows an exploded view of a shoe of a shoe massage system.

FIG. 1A shows an embodiment of an air bag 10 according to the present invention in a deflated state. The air bag includes a first monolithic layer 12 and a second monolithic layer 14. The first and second monolithic layer 12 and 14 are attached to each other along a closed line 15 that runs all around in a substantially elliptical shape. The first and second monolithic layers 12 and 14, along with the closed line 15, define a fluid chamber (not shown). The air bag 10 includes a fluid port 16 that is in fluid communication with the fluid chamber.

The first monolithic layer 12, within the closed line 15, is at least substantially corrugated in shape while the second monolithic layer within the closed line 15 (though not shown) is substantially planar. The corrugation of the first monolithic layer 12 is made up of ridges and grooves or waveforms. As illustrated, said corrugations are concentric, extending from a plateau in the central region of the closed line 15, towards the closed line 15. As such, the total corrugated surface area of the first monolithic layer 12 within the closed line 15 is larger than that of the second monolithic layer 14.

FIG. 1B shows a cross-sectional view about the line Y-Y of the embodiment of FIG. 1A. In FIG. 1B the first monolithic layer 12 and the second monolithic layer 14 are attached to each other along the closed line 15. Within the closed line 15, the first and second monolithic layers have overlapping surfaces wherein the surface area of the first monolithic layer 12 is larger than that of the second monolithic layer 14. The larger surface area of the first monolithic layer 12 is maintained within the closed line 15 by having said surface of the first monolithic layer 12 to be corrugated, i.e. it is shaped from a plurality of ridges and grooves (or waveforms) 13. The corrugated first monolithic layer 12 and the second monolithic layer 14, along with the closed line 15, define the above-mentioned fluid chamber 11. When the fluid chamber 11 is in its deflated state, the first monolithic layer 12 rests on the second monolithic layer 14 as shown.

FIG. 2A shows the embodiment of FIG. 1A in an inflated state. In the inflated state, the first monolithic layer 12 no longer appears corrugated as fluid (air) fills the fluid chamber 11 thereby forcing the expansion of the corrugated surface of the first monolithic layer 12 into a substantially parabolic shape with the plateau. The inflated state of the air bag is better illustrated in FIG. 2B which shows a cross-sectional view about the line Y-Y of the embodiment of FIG. 2A. In this embodiment, although the first monolithic layer 12 is substantially parabolic, the second monolithic layer 14 is essentially planar thereby giving rise to a substantially dome-shaped structure.

Alternatively, the second monolithic layer 14 may be adapted such that it adopts a parabolic shape as well when the air bag 10 is inflated thereby giving rise to a more circular structure (not shown) when viewed from its cross-sectional area about the line Y-Y. In addition, although in the illustrated embodiment, the first monolithic layer 12 is shown not to extend outside the closed line 15, it is to be noted that the area of the monolithic layers 12 and 14 outside of the closed line 15 may vary. However, the relationship within the closed line between the monolithic layers 12 and 14 remains the same in that the surface area of the first monolithic layer 12 always exceeds that of the second monolithic layer 14, with the excess being maintained within the closed line 15 by way of the first monolithic layer 12 being corrugated in shape, when the air bag is deflated.

FIG. 3A shows another embodiment of an air bag 20 according to the present invention in a deflated state. The embodiment of FIG. 3A is similar to that of FIG. 1A with the exception being that the air bag of FIG. 3A is arranged within a recess or cup 18 (as shown in FIG. 3B). Accordingly, as in FIG. 1A, the first monolithic layer 12 and the second monolithic layer 14 are attached to each other along a closed line 15 that runs all around in a substantially elliptical shape. The first and second monolithic layers 12 and 14, along with the closed line 15 define the fluid chamber 11 (shown in FIG. 3B) and said fluid chamber is in fluid communication with the fluid port 16.

As the air bag 20 illustrated in FIG. 3A is arranged within the recess 18, the second monolithic layer 14 tends to adopt the shape of the recess 18. Alternatively, the second monolithic layer 14 may be pre-formed to the shape of the recess to facilitate the assembly of the air bag 20 within the recess 18. In any case, as in the embodiment of FIG. 1A, the surface area of the first monolithic area 12 within the closed line 15 exceeds that of the second monolithic layer 14. Accordingly, the larger surface area of the first monolithic layer 12 is maintained within the closed line 15 by having said surface area shaped into a plurality of waveforms 13, as shown in FIG. 3B, which is a cross-sectional view about the line X-X of the embodiment of FIG. 3A. The waveforms 13 rest on the second monolithic layer 14 when the air bag 20 is in its deflated state and expand outwards, or unfold when air is pumped into the fluid chamber 11.

FIG. 4A shows the embodiment of FIG. 3A in an inflated state. As in FIG. 2A and FIG. 2B, the first monolithic layer 12 no longer retains its waveform as fluid (air) fills the fluid chamber 11 thereby forcing the expansion of the waveform of the first monolithic layer 12 into a substantially parabolic shape with the plateau. The inflated state of the air bag is better illustrated in FIG. 104B which shows a cross-sectional view about the line X-X of the embodiment of FIG. 4A. In this embodiment, although the first monolithic layer 12 is substantially parabolic, the second monolithic layer 14 is essentially planar thereby giving rise to a dome-shaped structure.

Unlike the embodiment of FIG. 2B, due to the placement of the air bag 20, specifically, the second monolithic layer 14, within the recess 18, the air bag 20 is constrained by the size and shape of the rigid recess 18 and thus, forms a dome-shape where the second monolithic layer 14 is at least substantially planar while the first monolithic layer 12 is substantially parabolic with the plateau.

FIG. 5 shows an exploded view of part of a massage shoe system. This part of the massage shoe system illustrates the docking mechanism 712 of a shoe (not shown). The shoe typically includes at least one air bag located within said shoe. The shoe itself has a recess in the sole 718 that accommodates the docking mechanism 712. The docking mechanism 712 is secured in place within the recess by way of a cover 720. As shown, the docking mechanism is located in the heel region of the sole 718, however, it may also be located further forward such as in the mid-sole region, for example.

The docking mechanism 712 is complementary to a docking mechanism of a power source or fluid pump system. When not in use, the docking may be covered with a cover 714 to prevent dirt from clogging the fluid channels of the docking mechanism 712. The docking mechanism 712 is connected to the air bag within the shoe via fluid flow tubes 716.

FIG. 6 shows an exploded view of the sole 718 of a shoe massage system. The sole 718 is generally hollow to accommodate, generally in the heel and mid-sole region, docking mechanism 712 and fluid flow tubes 716, as described above. The fluid flow tubes 716 are connected to a valve body 101, which, in combination with an actuating mechanism 111, forms a valve mechanism. An in-sole cover 1002 covers the hollow sole 718. The in-sole cover 1002 includes at least one air bag 1004. The air bag 1004 may be situated either directly on the lateral surface of the in-sole cover 1002 or beneath another layer of material, such as neoprene for example.

FIG. 7 shows another embodiment of an exploded view of a sole of a shoe massage system of FIG. 6. This embodiment is very similar to that of FIG. 6 with the exception being that the air bag 1004 is provided with a recess 1008 within the in-sole which the said air bag 1004 is located. The recess 1008 is situated in midway on the in-sole cover 1002.

FIG. 8 shows an exploded view of a shoe 110 of a shoe massage system. The shoe 110 has a sole 102. The sole, as described above, includes at least one air bag 104 arranged in a hollow portion of the sole. The air bags 104 are covered by a layer of material 106, such as neoprene or nylex for example, although any other suitable material may be used. The covering layer 106 provides a relatively uniform surface to the sole within the shoe 110. In addition, said layer 106, in the case of neoprene, helps to dissipate any build-up of heat within the shoe thus reducing the tendency for the foot to sweat and the development of foul odors.

The shoe 110 also includes at least two more air bags 108 and 112. The air bags 108 and 112 are situated along the lateral walls of the shoe such that the lateral surface and plantar arch regions of a foot of a user contact the air bags 108 and 112, respectively.

It should be noted that the exemplary embodiments described above merely serve to aid in the understanding of the various aspects of the present invention. Accordingly, said various aspects of the present invention are not to be construed to as being limited to said exemplary embodiments, but rather, as defined by the claims that follow.

1. An air bag for applying massage forces to a body comprising:
a first monolithic layer;
a second monolithic layer,
said first and second monolithic layer being attached to each other along a closed line such that the surface area of the first monolithic layer within the closed line is larger than the surface area of the second monolithic layer within said closed line, the first monolithic layer and the second monolithic layer defining a fluid chamber bounded by said closed line, wherein the first monolithic layer rests on the second monolithic layer and is of an at least substantially corrugated shape when said fluid chamber is deflated; and
at least one fluid port in fluid communication with the fluid chamber.

2. The air bag according to claim 1, wherein the first monolithic layer comprises, within said closed line, a plurality of ridges and grooves and/or a plurality of waveforms.

3. The air bag according to claim 2, wherein the ridges and grooves and/or the waveforms are at least substantially concentric.

4. The air bag according to claim 1, wherein the first and second monolithic layers are of a single layer.

5. The air bag according to claim 1, wherein the first monolithic layer comprises at least one node on its outer surface and within the closed line, said node being adapted to apply a massage force to a body when the fluid chamber is inflated.

6. The air bag according to claim 1, wherein the first and second monolithic layers are further attached to each other along at least one attachment line within the closed line thereby sub-dividing the fluid chamber into at least two sub-chambers.

7. The air bag according to claim 6, wherein the attachment line is another closed line that defines one of the sub-chambers and has at least one fluid port in fluid communication therewith.

8. The air bag according to claim 6, wherein the attachment line is defined so that the sub-chambers are in fluid communication with each other.

9. The air bag according to claim 1, wherein the first and second monolithic layers are formed of a polymeric material suited for molding or vacuum forming.

10. (canceled)

11. The air bag according to claim 1, wherein the fluid that inflates the fluid chamber and/or sub-chambers is a gas.

12. (canceled)

13. The air bag according to claim 1, wherein the closed line is at least substantially rectangular, polygonal, circular and/or elliptical.

14. An air bag apparatus comprising:
an air bag as defined in claim 1; and
a fluid pump system connected to the fluid port of the air bag.

15. The air bag apparatus according to claim 14, wherein the fluid pump system comprises:
a fluid pump adapted to connect to the fluid port of the air bag;
a valve connected to the fluid pump to control the directional flow of the fluid;
a controller, wherein said controller is adapted to regulate the fluid pump and valve thereby controlling the inflation and deflation of the air bag;
a pressure regulatory sensor in connection with the fluid pump and/or air bag; and
a power source electrically coupled to the fluid pump, valve controller and/or pressure regulatory sensor.

16. (canceled)

17. A massage shoe system comprising:
a pair of shoes or boots, each having at least four air bags, wherein each air bag comprises:
a first monolithic layer;
a second monolithic layer,
said first and second monolithic layer being attached to each other along a closed line such that the surface area of the first monolithic layer within the closed line is larger than the surface area of the second monolithic layer within said closed line, the first monolithic layer and the second monolithic layer defining a fluid chamber bounded by said closed line, wherein the first monolithic layer rests on the second monolithic layer and is of an at least substantially corrugated shape when said fluid chamber is deflated; and
at least one fluid port in fluid communication with the fluid chamber; and
a fluid pump system connected to the shoes via a docking mechanism.

18. (canceled)

19. (canceled)

20. (canceled)

21. (canceled)

22. (canceled)

23. (canceled)

24. The massage shoe system according to claim 17, further comprising at least one recessed cup located on the sole of the shoe, said recessed cup being capable of housing at least one air bag.

25. The massage shoe system according to claim 24 wherein the recessed cup is located in the heel region and/or mid-sole region of the shoe.

26. The massage shoe system according to claim 17, wherein two air bags are arranged within each shoe to provide a massage force to the heel region and/or sole region of a foot, and the remaining two air bags are arranged within each shoe to provide a massage force to the vamp region, plantar arch region, lateral region, calcaneal tubercle region, sides of the calcaneus, tarsal region, dorsal region and digital region of the foot.

27. The massage shoe system according to claim 17, wherein each of the four air bags is arranged beneath a layer of elastic material.

28. (canceled)

29. The massage shoe system according to claim 17, wherein the heel region and/or the sole region of the shoe comprises a docking mechanism that is adapted to dock with an independent power supply and/or fluid pump.

30. The massage shoe system according to claim 17, wherein the docking mechanism is of two parts with one part located on the fluid pump system and the other located on the shoes, each part being complementary to the other, such that when the shoes are docked with the fluid pump system, each of the air bags is in fluid connection with the fluid pump system via said fluid port.
